(19) United States
(12) Patent Application Publication
(10) Pub. No.: US 2016/0362090 A1
(43) Pub. Date: Dec. 15, 2016

(54) TRUCK WASH PADDLE

(71) Applicant: JAMES RICHARD DOUGLAS, Murrieta, CA (US)

(72) Inventor: JAMES RICHARD DOUGLAS, Murrieta, CA (US)

(21) Appl. No.: 14/737,610

(22) Filed: Jun. 12, 2015

(51) Int. Cl. B60S 3/04

(52) U.S. Cl. CPC B60S 3/045

(57) ABSTRACT

A tool is disclosed that facilitates use of a vehicle wash mitt of the type having an interior of predetermined size for receiving a human hand. The tool is referred to as a truck wash paddle assembly for use in washing difficult-to-reach portions of the user's pickup truck or other vehicle. It includes an object referred to as a mitt-holding member (i.e., an MHM) on which a user mounts an elongated handle to form the tool. The MHM includes a body of material having a size and shape that fits within the interior of the wash mitt in the place of the human hand. A handle-receiving portion of the MHM defines a handle-receiving bore for receiving the end portion of an elongated handle. Preferably, an interiorly threaded metal insert within the bore mates with the exteriorly threaded end portion of a commonly available handle having an Acme-type thread. Simply removing the wash mitt from the MHM readies it for independent use, cleaning, and storage.

### BACKGROUND OF THE INVENTION

1. Technical Field

The present invention relates generally to automotive maintenance, and more particularly to a device that facilitates use of a wash mitt in washing hard-to-reach portions of a pickup truck or other vehicle.

2. Description of Related Art

The terms “car wash mitt,” “truck wash mitt,” “vehicle wash mitt,” and just “wash mitt” as used herein (and variations thereof) include any of various commercially available vehicle-washing accessories that a user dons on one hand for use in washing a vehicle. A typical wash mitt appears something like a mitten without a thumb compartment; it is a pouch-like object made of a suitable material that the user's hand fits in. A right-handed user dons the wash mitt on their right hand and then moves it across the outer surface of a vehicle in order to apply soap to the vehicle surface and to thereafter rinse it. Wearing a wash mitt helps the user cover a larger vehicle surface area with less effort. The wash mitt with the product designation “X3002 Microfiber Wash Mitt” that is available from Meguiar's, Inc. of Irvine, Calif., provides a wash mitt example.

Although wash mitts are effective in many respects, users nevertheless experience difficulty in washing hard-to-reach portions of their vehicles (i.e., portions of the vehicle that are difficult to reach). Pickup truck surfaces intermediate the bed (i.e., the box) and the cab, for example, are often difficult to reach for an individual of average size, as are surfaces on the roof and some portions of the hood. Surfaces on the interior of the box can be difficult to reach, too. Thus, users can use wash mitts effectively on some portions of their vehicles, but they have difficulty with other portions, and this problem becomes more noticeable with physical limitations of the users, including advanced age.

### SUMMARY OF THE INVENTION

In view of the foregoing, it is a primary objective of the present invention to provide a tool for facilitating wash mitt use. The present invention achieves this objective by providing what may be referred to as a “truck wash paddle assembly.” It includes a mitt-holding member (i.e., an MHM) on an elongated handle. The MHM is sized and shaped to fit within a selected wash mitt in place of the user's hand in order to thereby hold the wash mitt. It includes a handle-receiving bore so that a user can mount the MHM on an end portion of the elongated handle. The user places the wash mitt on the MHM, grasps the elongated handle, and proceeds to wash hard-to-reach portions of their pickup truck or other vehicle with the wash mitt. The user removes the wash mitt from the MHM for independent use (i.e., separate from the MHM), and for cleaning and storage.

The MHM is an object that takes the form of a body of material (e.g., molded polyethylene) having a size and shape that fits within the interior of the wash mitt in the place of the human hand. Preferably, the fit is sufficiently snug so that the wash mitt is held firmly enough that it does not fall off of the MHM during use. A user simply mounts the wash mitt and the handle on the MHM for use in washing hard-to-reach portions of a vehicle.

A handle-receiving portion of the MHM defines a bore for receiving an end portion of the elongated handle. Preferably, the handle-receiving portion of the MHM is interiorly threaded for threaded engagement of an exteriorly threaded end portion of the handle. The handle member may take the form of any of various, exteriorly threaded handles used for household brooms and mops, those used for some garden tools, and other similar handles and the like. The MHM preferably includes a cylindrically shaped, interiorly threaded member (i.e., an interiorly threaded “insert”) within the bore that defines sturdy threads. The insert is preferably composed of a metal material for strength and durability.

Thus, the present invention provides a truck wash paddle assembly that facilitates the washing of hard-to-reach portions of a pickup truck or other vehicle using a readily available wash mitt. The following detailed description and accompanying illustrative drawings make the foregoing and other objectives, features, and advantages of the invention more apparent.

### BRIEF DESCRIPTION OF THE DRAWINGS

FIG. 1 of the drawings is an exploded view of a truck wash paddle assembly constructed according to the invention (i.e., the combination of an MHM and a handle) along with a typical wash mitt that is used with the truck wash paddle assembly in washing a vehicle;

FIG. 2 of the drawings is a perspective view of a portion of the truck wash paddle assembly with the wash mitt and handle mounted on the MHM;

FIG. 3 is a side elevation view of the MHM, shown apart from the wash mitt and the handle;

FIG. 4 is an enlarged cross section of the bore-defining portion of the MHM, as viewed in a plane containing a section line 4-4 in FIG. 1, with an interiorly threaded, metal insert provided within the bore; and

FIG. 5 is an enlarged front view elevation view of the MHM, showing various dimensions.

### DESCRIPTION OF THE PREFERRED EMBODIMENTS

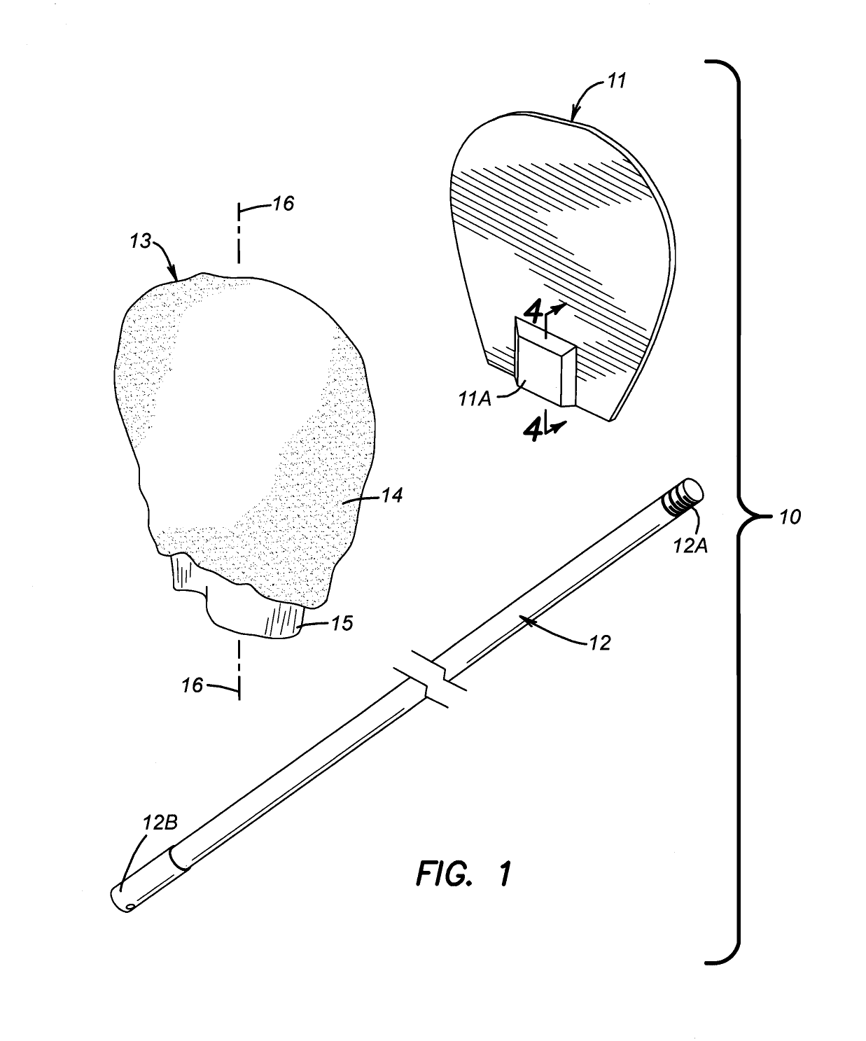

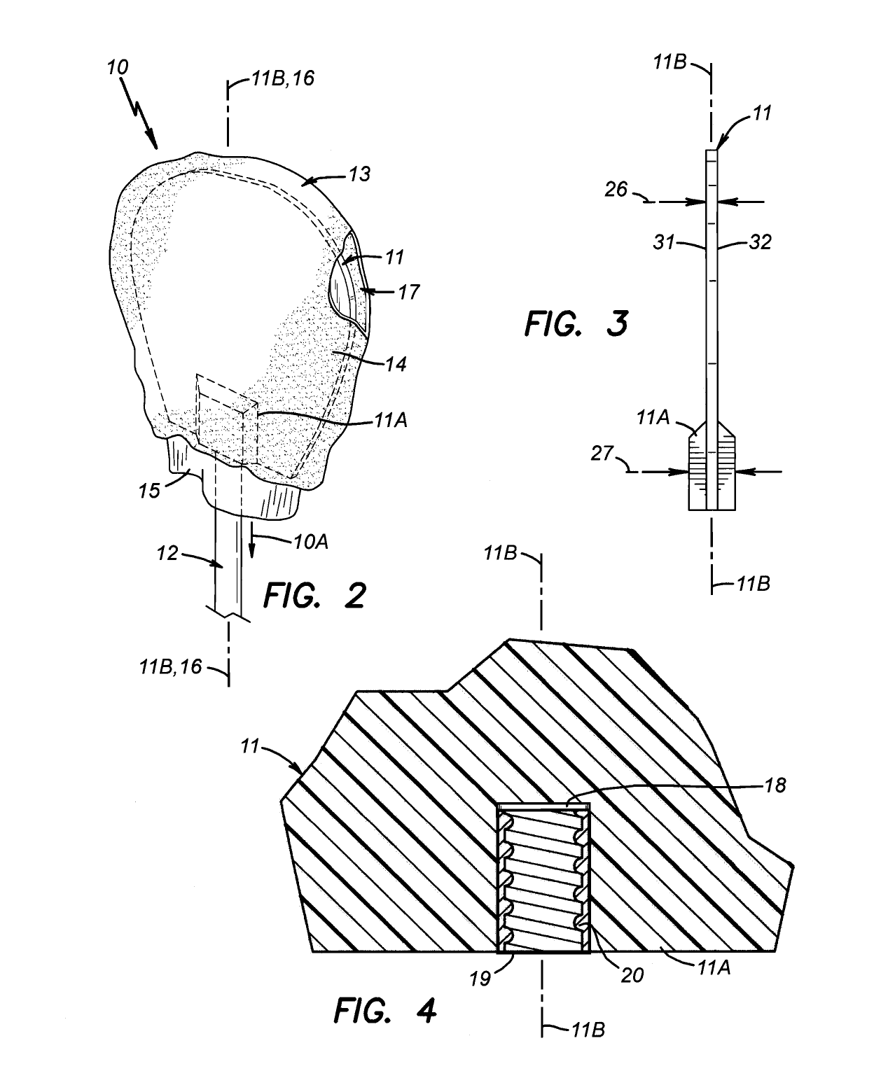

FIG. 1 of the drawings shows the components of a tuck wash paddle and mitt assembly 10 constructed according to the present invention. Generally, the assembly 10 includes a mitt-holding member (i.e., an MHM 11) and an elongated handle (i.e., a handle 12) that a user (not shown) assembles as a mitt-holding tool for use with a wash mitt (i.e., a mitt 13). With the MHM 11 and the handle 12 assembled to form the mitt-holding tool, the user mounts the mitt 13 on the MHM 11 to form the assembly 10 shown in FIG. 2. The user does so by sliding the mitt 13 onto the MHM 11 as depicted by an arrow 10A in FIG. 2. The user then grasps the handle 12 and manipulates the assembly 10 in order to wash and rinse difficult-to-reach places on the user's vehicle (not shown) with the mitt 13.

The mitt 13 may take the form of any of various commercially available wash mitts, including, for example, the large wash mitt (product no. 81008) that is available under the trademark PRESTA from Malco Products, Inc of Barberton, Ohio. It includes a main portion 14 and a two-inch-wide cuff portion 15, and it measures about eight inches wide by about eleven inches in overall length along a mitt central axis of elongation 16 (FIG. 1). The main portion 14 defines an interior 17 of the mitt 13 that is visible in FIG. 2, with the interior 17 being large enough to receive a large human hand (e.g., a hand measuring no more than about 6.5″ wide by about 8″ long). The main portion 14 is made, for example, from microfibers that easily release collected debris when rinsed with a hose, while the cuff portion 15 is made of an elasticized material. The user can stretch the cuff portion 15 circumferentially to facilitate placement onto a user's hand (or onto the MHM 11) and then allow the cuff portion 15 to shrink back toward its unstretched shape to help hold the mitt 11 on the hand or MHM 11, so that the mitt 13 does not come off the MHM 11 during vehicle-washing use.

The MHM 11 is a somewhat flat, hand-sized object (e.g., molded polyethylene) that fits within the interior 17 of the mitt 13. Preferably, the MHM 11 fits within the interior 17 of the mitt 13 somewhat snugly so that the mitt 13 does not come off of the MHM 11 during use. The MHM 11 includes a bore-defining portion 11A (FIGS. 1-5) that defines a handle-receiving bore 18 (FIG. 4). The handle-receiving bore 18 is interiorly threaded so that the user can screw an exteriorly threaded distal end portion 12A of the handle 12 (FIG. 1) into the MHM 11 to form the mitt-holding tool. The user then inserts the MHM 11 into the mitt 13, and that results in the assembly 10 shown in FIG. 2. Of course, the user can insert the MHM 11 into the mitt 13 first, and thereafter add the handle 12.

Preferably, the MHM 11 includes an interiorly threaded insert 19 disposed within the handle-receiving bore 18 (FIG. 4). The insert 19 includes an interior thread 20. The illustrated insert 20 is a cylindrically shaped member (e.g., composed of metal) that is retained in place within the bore 18 by a force fit, bonding, or other suitable means. The insert 20 provides a strong, durable interior thread 20 that mates with the exteriorly threaded distal end portion 12A of the handle 12. Of course, for an MHM made of metal or other strong, durable material (not shown) a threaded insert may not be necessary.

Any of various handles may be used. The illustrated handle 12 takes the form of a commonly used stick-type handle. It is a cylindrically shaped, wooden rod having a length from the distal end portion 12A to a proximal end portion 12B of about four feet, and a diameter of about 0.875 inches. The distal end portion 12A is exteriorly threaded with 0.75-inch diameter threads, five threads per inch (i.e., an Acme-type thread form). In the United States, most threaded handles for tools such as brooms, paint rollers, extension poles for window-washing brushes and squeegees, and so forth, have a threaded end with threads that are 0.75 inches in diameter, with five threads per inch (i.e., an Acme-type thread form). Consequently, those handles can be used with different tools; they are interchangeable. The thread tolerances are very loose, and some molded plastic threads do not use an Acme-type thread form at all, but they nevertheless function satisfactorily. The illustrated handle 12 takes the commonly used form described above, although other handles may be used instead within the broader inventive concepts disclosed.

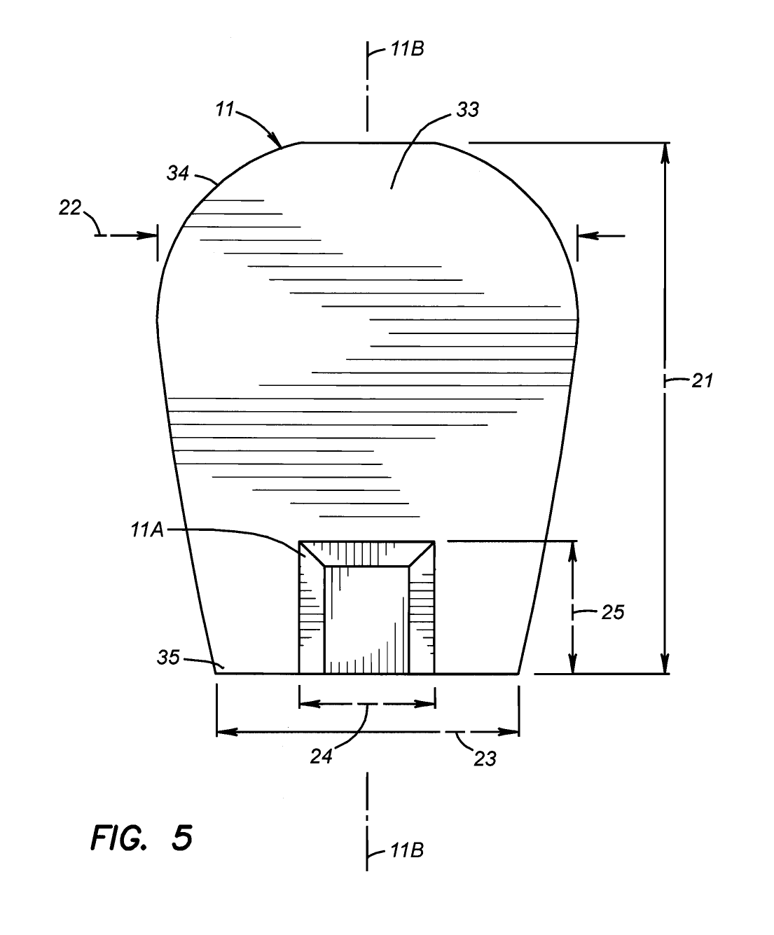

As a further idea of size, the illustrated MHM 11 has a length of about 8.0 inches along an MHM central axis of elongation 11B that is identified in FIGS. 2, 3, 4, and 5, as indicated by a dimension 21 in FIG. 5. It has a width of about 6.625 inches at its widest point, as indicated by a dimension 22 in FIG. 5, and it narrows to a width of about 4.5 inches as indicated by a dimension 23. The bore-defining portion 11A is about 2.0 inches by 2.0 inches as indicated by dimensions 24 and 25 in FIG. 5. In addition, the illustrated MHM 11 has a thickness throughout most of its length of about 0.375 inches as indicated by a dimension 26 in FIG. 3, with the bore-defining portion 11A having a thickness of about 1.0 inches as indicated by a dimension 27. Of course, those dimensions may vary significantly for alternate embodiments of an MHM constructed according to the broader inventive concepts disclosed (e.g., for use with even larger or with smaller wash mitts). Preferably, the thickness of an MHM constructed according to the invention (i.e., the dimension 26 of the MHM 11) is not less than about 0.125 inches and not more than about 1.0 inches, in order to achieve a good fit within the mitt 13 without significant MHM weight.

The claims specify that the MHM object is a body of material having a size and shape that fits within the interior of the wash mitt in the place of a human hand. The MHM fits within the interior of the wash mitt in the sense that it fills a substantial portion of the interior so that the mitt assumes a shape similar to how it is shaped when a human hand occupies the interior. For that purpose, the MHM 11 has first and second surfaces 31 and 32 (FIG. 3) that are at least somewhat parallel and at least somewhat planar (i.e., except for the bore-defining portion 11A). When the MHM 11 is occupying the interior of the mitt 13, one of the surfaces 31 and 32 takes the place of the palm of the human hand and the other surface takes the place of the back of the human hand. Thus, the surfaces 31 and 32 bear outwardly against the mitt 13, and the mitt 13 bears inwardly against the surfaces 31 and 32, as the mitt 13 is moved in various orientations across a surface of a truck or other vehicle for vehicle washing and rinsing purposes.

In order to avoid damaging the mitt 13, the MHM 11 has no sharp edges or abrupt angular protrusions throughout its distal portion (i.e., a forward portion 33 (FIG. 5). The forward portion 33 is that portion of the MHM 11 disposed from the bore-defining portion 11A to a forward edge 34 of the MHM 11. The forward edge 34 is curved as illustrated to avoid having the MHM 11 snag the mitt 13 as the user inserts the MHM 11 into the mitt 13. In order to further avoid snagging and facilitate insertion and removal, the shape of the MHM 11 narrows from its widest point (i.e., at the dimension 22) to a proximal end portion 35 at the dimension 23.

Thus, the present invention facilitates the washing of hard-to-reach portions of a pickup truck or other vehicle using a readily available wash mitt. Although an exemplary embodiment has been shown and described, a person having ordinary skill in the art may make many changes, modifications, and substitutions without necessarily departing from the spirit and scope of the present invention. As for the specific terminology used to describe the exemplary embodiments, it is not intended to limit the invention; each specific term is intended to include all technical equivalents that operate in a similar manner to accomplish a similar purpose or function.

What is claimed is:

1. An object for facilitating use of a wash mitt of the type having an interior of predetermined size for receiving a human hand, the object comprising:
a body of material having a size and shape that fits within the interior of the wash mitt in the place of the human hand; and
a handle-receiving portion of the body of material that defines a bore for receiving an end portion of an elongated handle;
whereby a user can mount the wash mitt and the handle on the object for use in washing hard-to-reach portions of a vehicle.

2. An object as recited in claim 1, wherein the handle-receiving portion includes threads within the bore for threaded engagement of the end portion of the handle.

3. An object as recited in claim 1, further comprising an interiorly threaded member within the bore that defines threads for threaded engagement of the end portion of the handle.

4. An object as recited in claim 3, wherein the body of material is at least partially composed of plastic, and the threaded member is composed at least partially of metal.

5. An object as recited in claim 1, wherein the body of material includes two surfaces that are at least somewhat planar and somewhat parallel, and a thickness between the two surfaces lying in a range of about 0.125 inches to about 1.0 inches.

6. An object as recited in claim 1, wherein the body of material includes a curved forward edge that is curved as to avoid having the body of material snag the wash mitt as the user inserts the body of material into the wash mitt.

7. A tool for facilitating use of a wash mitt of the type having an interior of predetermined size for receiving a human hand, the tool comprising:
a mitt-holding member; and
a elongated handle member mounted on the mitt-holding member;
said mitt-holding member including a body of material having a size and shape that fits within the interior of the wash mitt in the place of the human hand;
said mitt-holding member including a handle-receiving portion that defines a bore for receiving an end portion of the handle member; and
said end portion of the elongated handle member being mounted within said bore;
whereby a user can mount the wash mitt and the handle on the mitt-holding member for use in washing difficult-to-reach portions of a vehicle.

8. A tool as recited in claim 7, wherein the handle-receiving portion includes threads within the bore for threaded engagement of the end portion of the handle.

9. A tool as recited in claim 7, further comprising an interiorly threaded member within the bore that defines threads for threaded engagement of the end portion of the handle.

10. A tool as recited in claim 7, wherein the body of material is at least partially composed of plastic, and the threaded member is composed at least partially of metal.

11. A tool as recited in claim 7, wherein the body of material includes two surfaces that are at least somewhat planar and somewhat parallel, and a thickness between the two surfaces lying in a range of about 0.125 inches to about 1.0 inches.

12. A tool as recited in claim 7, wherein the body of material includes a curved forward edge that is curved as to avoid having the body of material snag the wash mitt as the user inserts the body of material into the wash mitt.
